(19) United States
(12) Patent Application Publication
(10) Pub. No.: US 2013/0191251 A1
(43) Pub. Date: Jul. 25, 2013

(54) END-TO-END IN-STORE ONLINE GIFTING PLATFORM

(71) Applicants: Yaacov M. Martin, Columbus, OH (US); Shaul H. Weisband, Columbus, OH (US)

(72) Inventors: Yaacov M. Martin, Columbus, OH (US); Shaul H. Weisband, Columbus, OH (US)

(21) Appl. No.: 13/733,292

(22) Filed: Jan. 3, 2013

Related U.S. Application Data
(60) Provisional application No. 61/589,691, filed on Jan. 23, 2012.

(51) Int. Cl. G06Q 30/06; G06Q 50/00

(52) U.S. Cl. CPC G06Q 30/0601; G06Q 50/01
USPC 705/26.61

(57) ABSTRACT

In one embodiment, a gifting platform allows users to select, share, and receive gifts directly from a store. Specifically, a user can locate a desired item in a brick-and-mortar store, scan the item's barcode using an associated app, and share the item through social networks and email to friends and family. Members of the user's social circle may then purchase the item for the user, such that the user is then provided with a gift/confirmation number (e.g., to their mobile phone) to purchase the item from the store.

### CROSS-REFERENCE TO RELATED APPLICATIONS

The present application claims priority to U.S. Provisional Patent Application Ser. No. 61/589,691, entitled “Jifiti Method of Effecting Sales and Gifting,” which was filed by Martin et al. on Jan. 23, 2012, the contents of which being incorporated by reference herein in its entirety.

### TECHNICAL FIELD

The present invention relates generally to computer programs and applications, and, more particular, to the fusion of online gifting and in-store shopping.

### BACKGROUND

Many people generally enjoy browsing their favorite stores and malls, trying on clothes or playing with gadgets. However, many people also do not take the next step of actually completing a purchase of the items, regardless of how much they like them, and move along. At the same time, these people quite often have friends and family members who would enjoy purchasing something for these people. Typically, without knowing exactly what someone wants, such purchases are given to others as “hit-or-miss” gift items, or the even less personal option of gift cards.

In particular, gift-giving might seem like a routine activity for most people since gifts account for more than 4% of the typical household budget. However, research shows that many people struggle when giving gifts as evidenced by the almost 50% return rate at the holidays or knowing that a third of Americans have “re-gifted” a present. Gift registries have been in existence for some time and studies show people are more appreciative of gifts they explicitly request; however, existing registries tend to focus on certain life events, like weddings and births, and are limited to a few stores. Additionally, gift registries are a costly investment for retailers to develop and maintain.

### SUMMARY OF THE INVENTION

According to one or more embodiments herein, a gifting platform allows users to select, share, and receive gifts directly from a store. Specifically, a user can locate a desired item in a brick-and-mortar store, scan the item's barcode using an associated application (“app”), share the item through social networks and/or email to friends and family. Members of the user's social circle may then purchase the item for the user on a gifting platform/website, so that the user is then provided with a gift/confirmation number (e.g., to their mobile phone) to purchase the item from the store.

Specifically, in one illustrative embodiment, a particular merchant is selected, and a product code of a particular product, selected by a user, is received by a processing system. The system may identify, according to the product code and the particular merchant, details of the particular product and an associated product price. Next, the details (e.g., and image) of the particular product, the particular merchant, and the associated product price may be shared with one or more members of a social network of is the user, where the sharing solicits one or more members to contribute funds toward a voucher for purchase (generally of the particular product) by the user from the particular merchant. When sufficient contributed funds for purchase of the particular product are received (or if the user/recipient chooses to “cash-in”), a notification is provided for the user that has a redemption code of the voucher for use with the particular merchant.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example network environment;

FIG. 2 illustrates an example simplified procedure for end-to-end in-store online gifting;

FIGS. 3-8B illustrate example user interfaces of an application for use with end-to-end in-store online gifting;

FIGS. 9-10 illustrate example user interfaces of a website for use with end-to-end in-store online gifting;

FIGS. 11A-11B illustrate another example simplified procedure for end-to-end in-store online gifting; and

FIG. 12 illustrates an example computing system architecture.

### DESCRIPTION OF EXAMPLE EMBODIMENTS

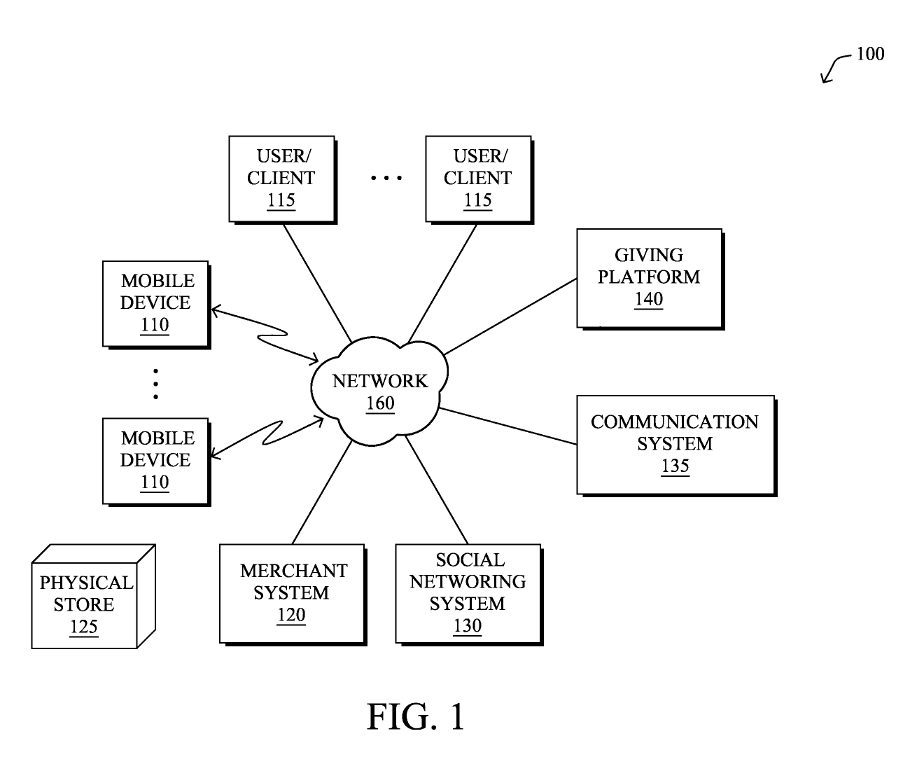

Particular embodiments may operate in, or in conjunction with, a wide area network environment, such as the Internet, including multiple network addressable systems. FIG. 1 illustrates an example network environment 100, in which various example embodiments may operate. Network cloud 160 generally represents one or more interconnected networks, over which various systems and hosts described herein may communicate. Network cloud 160 may include packet-based wide area networks (such as the Internet), private networks, wireless networks, satellite networks, cellular networks, paging networks, and the like. Various client devices and/or systems may be in communication with the network 160, such as mobile devices 110 (e.g., phones, tablets, etc., illustratively via cellular networks, WiFi networks, and so on) or stationary devices 115 (e.g., personal computers, desktops, etc.). One or more systems (e.g., servers, websites, databases, etc.) may also be in communication with the network 160, such as a merchant system/database 120 (which may or may not be located with a physical store 125 of the merchant), a social media/networking system 130 (e.g., servers and databases associated with social media), and a communication system 135 (e.g., servers and databases associated with communication, such as emailing, text messaging, etc.). As discussed herein, a specific “gifting platform” 140 may also be present in the environment 100, configured and operational as described below.

Generally, the client devices, application servers, enterprise servers, etc. of FIG. 1 may be operably connected to the network environment 100 and network cloud 160 via a network service provider, a wireless carrier, a set of routers or networking switches, or any other suitable means. Each client device, application server, or enterprise server may generally be a computer, computing system, or computing device including functionality for communicating (e.g., remotely) over a computer network. Client devices 110/115 in particular may be a desktop computer, laptop computer, personal digital assistant (PDA), smart phone or other cellular or mobile device, or mobile gaming device, among other suitable computing devices.

In one example embodiment, the network environment 100 comprises computing systems that allow users at client devices 110/115 to communicate or otherwise interact with each other and access content, as described herein. For instance, client devices 110/115 may execute one or more client applications, such as a web browser (e.g., MICROSOFT WINDOWS INTERNET EXPLORER, MOZILLA FIREFOX, APPLE SAFARI, GOOGLE CHROME, etc.), to access and view content over the computer network 160. In particular implementations, the client applications allow a user of client device to enter addresses of specific network resources to be retrieved, such as resources hosted by a social network environment, web application servers, or enterprise servers. These addresses can be Uniform Resource Locators (URLs). In addition, once a page or other resource has been retrieved, the client applications may provide access to other pages or records when the user “clicks” on hyperlinks to other resources. By way of example, such hyperlinks may be located within the web pages and provide an automated way for the user to enter the URL of another page and to retrieve that page. Furthermore, as will be readily understood by those skilled in the art, an application or “app” may also provide a user interface (e.g., a graphical user interface or “GUI”) that can be used by users (clients) for interaction and access.

As noted above, people often browse their favorite stores (125) and malls for clothes or other items, though they may not actually purchase the items. As also noted, however, friends and family members would like to know exactly what these people want, to avoid “hit-or-miss” gift items or simple (and impersonal) gift cards. The systems and techniques herein provide a gifting platform that allows users to spot, share, and redeem gifts while walking through stores 125. In particular, as described below, users may walk through a store (e.g., their favorite stores), notice merchandise that they would enjoy receiving as a gift, and the platform provides a mechanism to tell their friends and family how they would like to receive that merchandise as a gift. The friends and family (also referred to as members of a “social network” or “social circle”) can buy the requested gift(s) or contribute (“chip in”) through an interface of the gifting platform (e.g., interacting with a website). The user then receives a purchase notification (e.g., to a mobile app), which contains a voucher that can be redeemed at the store (or online) for the merchandise.

The techniques described herein improve the gifting industry in such a manner that gift recipients are sure to get what they want, particularly making it more manageable for merchants/retailers to offer gifting as a service to their customers. For instance, the techniques herein expand the conventional gift registry concept to all occasions and every variety of merchandise, utilizing existing and new technology to facilitate the selection and redemption of gifts. In addition, the techniques incorporate the real-time shopping atmosphere in a fun and interactive manner, capitalizing on today's social exchange phenomenon. As also described herein, the techniques provide is merchants/retailers with valuable analytics on customer buying habits and preferences.

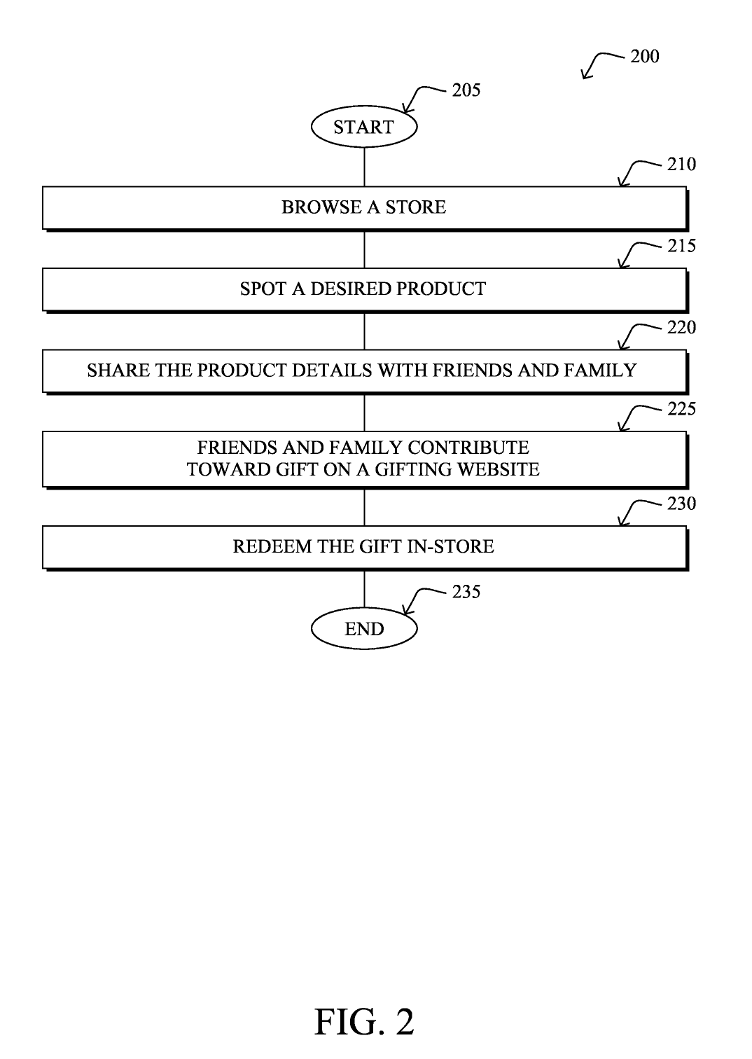

As a brief introduction, FIG. 2 illustrates an example simplified procedure 200 for end-to-end in-store online gifting in accordance with one or more embodiments described in greater detail below. The procedure 200 starts at step 205, and continues to step 210, where a user browses a store (e.g., in person or online), and “spots” (locates, sees, detects, determines, etc.) a desired product in step 215. Using the gifting platform 140 as described herein, the user may then share the product details with friends and family in step 220, such that friends and family can contribute toward the gift on the gifting website in step 225. (Generally, as described herein, transactions take place on a provided “gifting platform” and need not (or does not) redirect to the brand's/retailer's website, thus multiple “gifts” from various stores may be purchased with a single checkout.) Once sufficient funds are reached (or the user/recipient decides to “cash-in”) and a voucher or gift card is issued, in step 230 the user redeems the voucher in-store (or online) to obtain the gift, and the simplified procedure ends in step 235.

Operationally, according to one or more embodiments described herein for end-to-end in-store online gifting, the gifting platform 140 allows users to share their desired items while walking through stores, such that friends and family of the user can gift the desired item to the user. Illustratively, the platform may be presented to a user as an application or “app” which can be downloaded to any smartphone or other mobile device (e.g., tablets) and makes the mobile device ready to facilitate the gift registry process. The app on the personal device 110/115 of the user (e.g., presented as a graphical user interface or “GUI” to the user on the personal device) may perform various user-interaction activities, such as receiving user input and displaying notices to the user, while on the back-end, the app may be in remote communication with one or more servers (e.g., gifting platform 140).

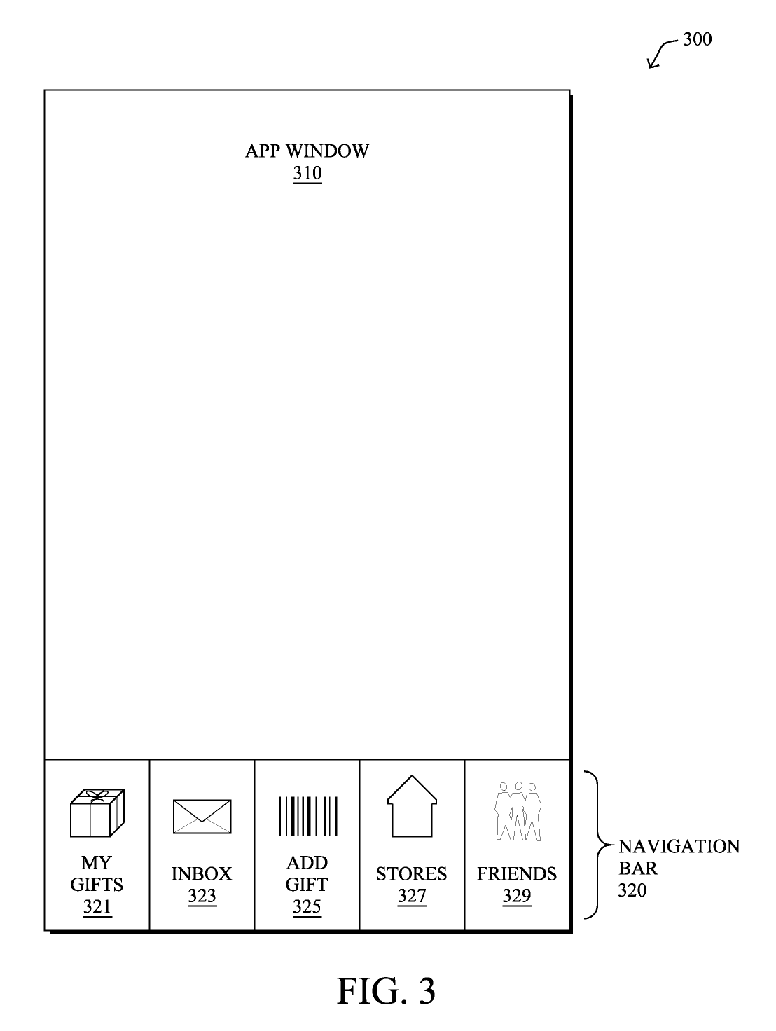

FIG. 3 illustrates an example user interface 300 that may be displayed to users on their mobile device 110 as an app GUI (e.g., a touch-screen), as may be appreciated by those skilled in the art. In particular, the interface 300 may comprise an app window 310 is for displaying various content as described below, and a navigation bar 320 that may or may not be persistent (consistently the same) among various displays (or “screens”). Illustratively, an example navigation bar 320 may comprise a button or link for “my gifts” 321, where a user can add and manage gifts, such as tapping on a gift in the list to share, edit, or see its status. An “inbox” tab 323 may be selected to display the user's notifications (e.g., a personal gift basket), where a new notification is received each time someone buys the user a gift (or contributes), such that as described below, the user may redeem a voucher and check out of the store using a code (e.g., barcode) found in the message. An “add gift” button 325 allows users to add a gift to their wish-list, such as by selecting the store they are in and scanning (or typing) a barcode, as detailed below. In particular, as described below, when adding a gift to a wish-list, the app allows users to share the gifts (or list) via email, text messaging (simple/short message service or “SMS”), or social media/networks. Stores button 327 may be used to allow users to locate stores in their area that participate in the gifting platform, such as simply listing all stores, listing all stores by category, by location (e.g., on a map or based on GPS discovery of the user's location), etc. A “friends” button 329 may be selected to view members of the user's social circle, and/or to see those members who also have configured their mobile devices to use the gifting platform (and to invite those who haven't) as well as suggesting a gift for a friend or even purchasing a gift and sending the attached voucher directly to a friend.

The interface 300 as shown in FIG. 3, as well as any interface or display shown in FIGS. 3-10, are merely illustrative examples to demonstrate the functionality of the gifting platform. The interfaces and/or webpages are not meant to limit the scope of the present invention, and are merely representative examples. For instance, placement of icons and/or text, as well as the particular icons and/or text, are merely examples, and more, fewer, and/or different icons and/or text may be used in accordance with the techniques herein.

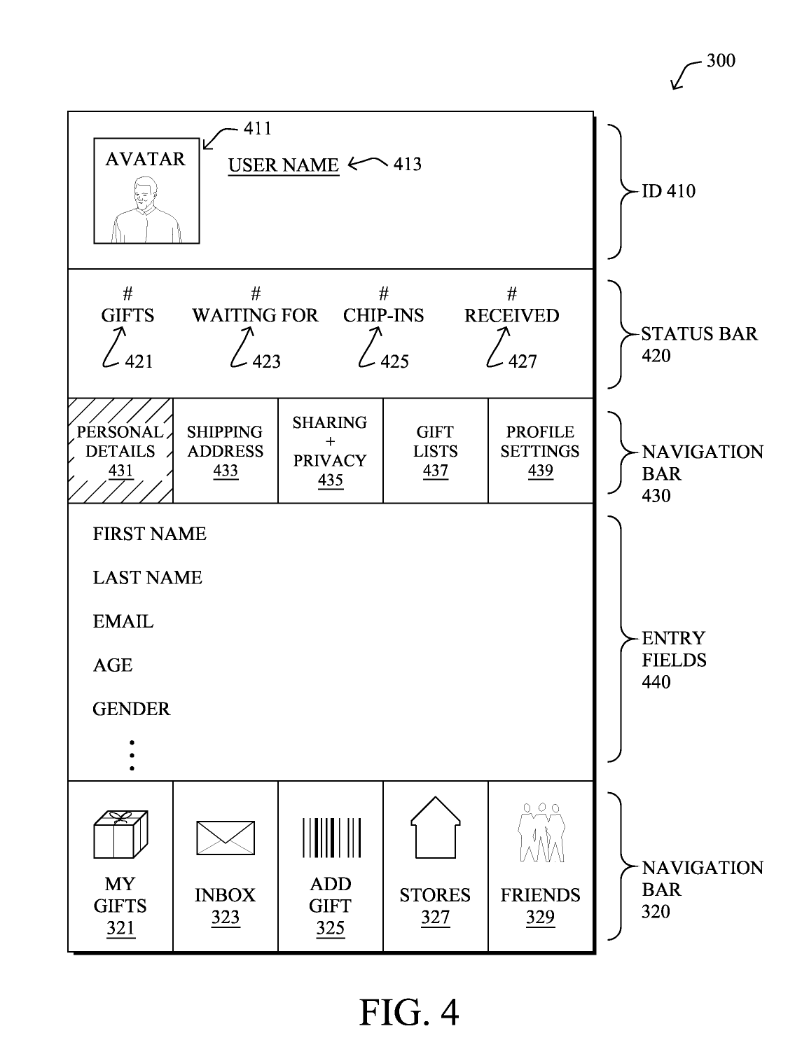

FIG. 4 illustrates the app interface 300 displaying a user profile page, such as where a user may perform account set-up, manage lists, etc. For example, an identification (ID) portion 410 may display a user's avatar or image 411 and his or her user name 413 (which may or may not be his or her actual name, as will be readily understood by those skilled in the art). Within an example status bar 420, a user may be shown a number of gifts total 421 for which the user has used the gifting platform, a number of gifts 423 for which the user is still waiting, a number of gifts 425 that are being “chipped into” (described below), and a number of received gifts 427. Within another navigation bar 430, users may be allowed to edit their personal details 431 (shown as selected), their shipping address 433, sharing and privacy settings 435, gift lists 437, and profile settings 439. Depending upon which selection is made within the navigation bar 430, the entry fields 440 may display the appropriate information, fields, and selections (e.g., personal details being shown, such as name, email, age, gender, etc.).

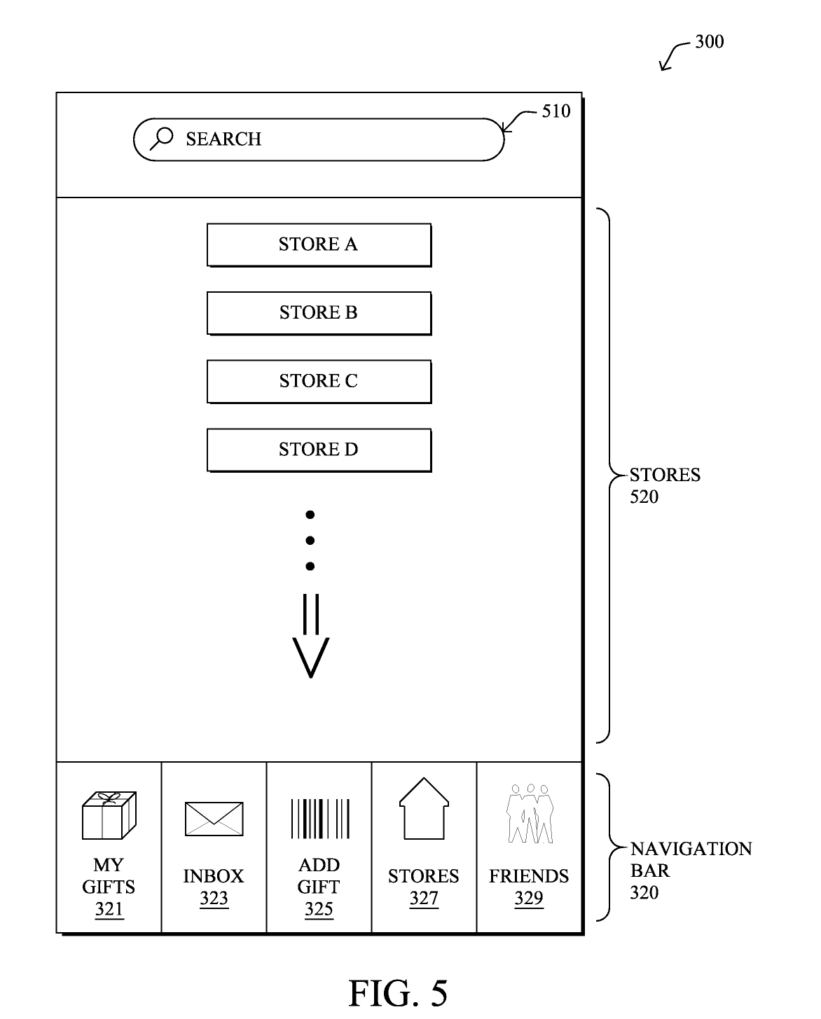

According to the gifting platform techniques herein, a user may enter a gifting platform member store. The store itself (physical store 125) may be known by the user as a member store, or may be located using the app as shown in FIG. 5. For instance, a user may search for store names, locations (towns, malls, etc.), and/or categories in search bar 510, and/or may select a store from a list of stores 520. Note that the list of stores 520 may appear as a map, and/or may be populated based on GPS location. Alternatively, the store may be marked with a sign or window sticker indicating that it is a member store. For example, a matrix barcode (e.g., a “Quick Response Code” or “QR Code”) located at a store of the particular merchant may be scanned and deciphered by the user's mobile device (e.g., using a camera of the mobile device) either first to obtain the app (downloading the app from a website linked to the matrix barcode, as will be understood), check into the particular store/merchant, or even add a gift directly to his/her gift list.

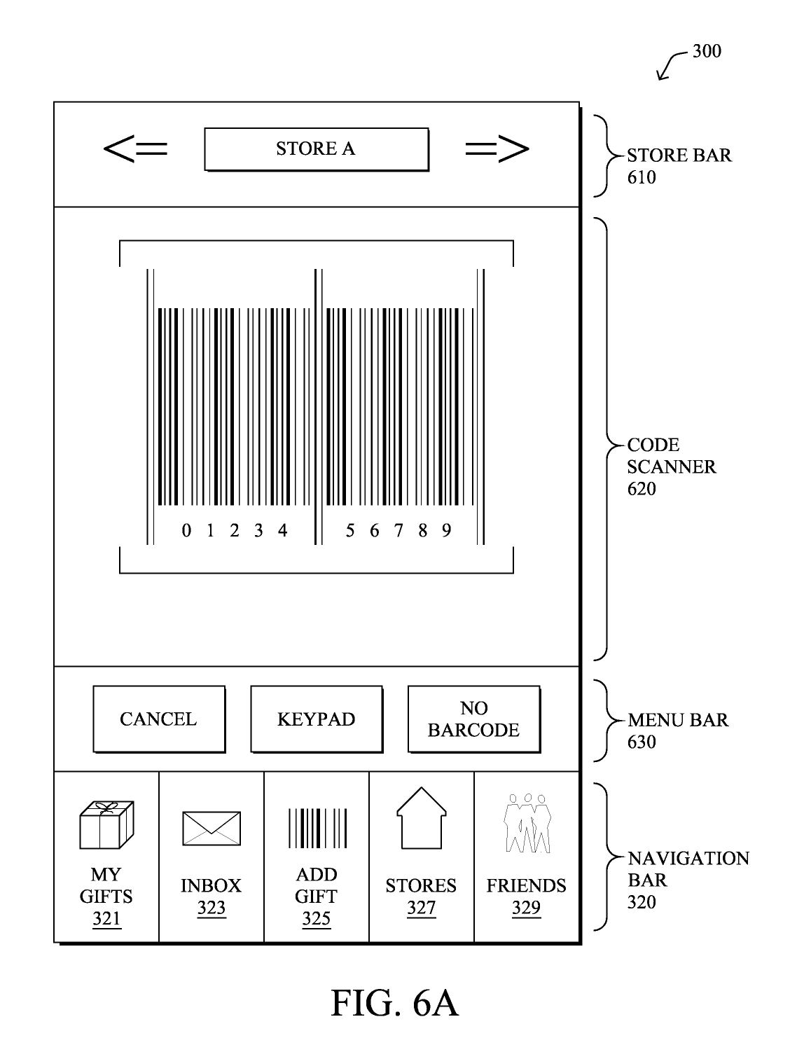

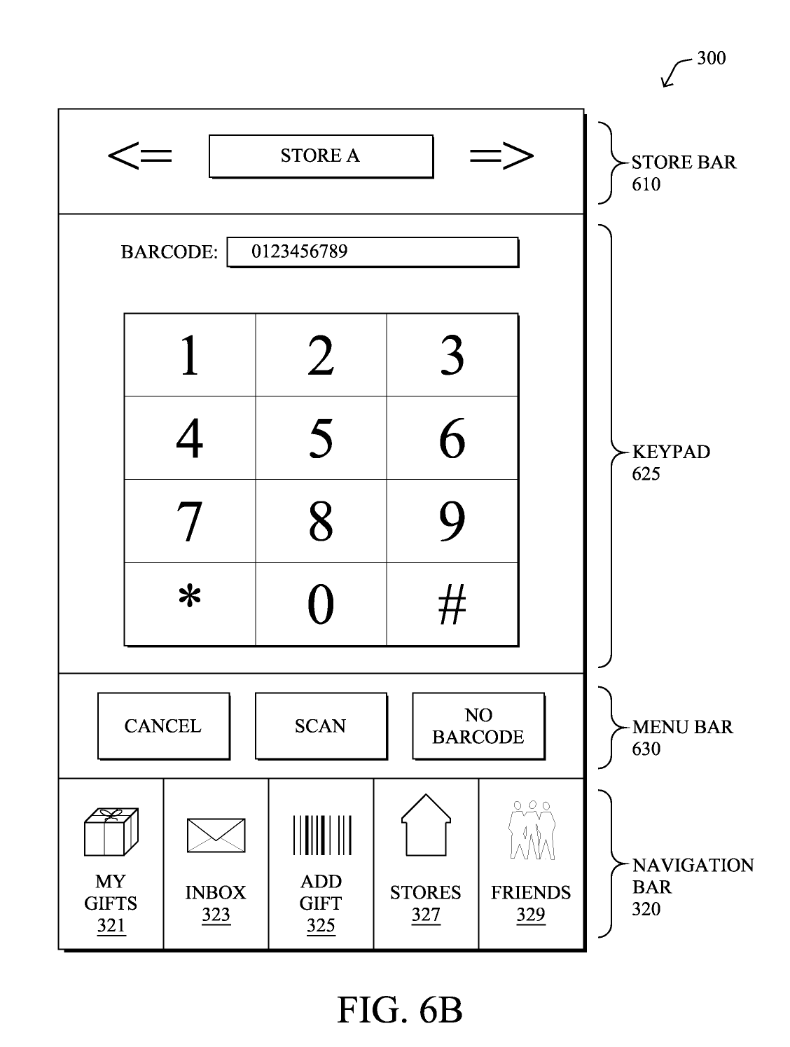

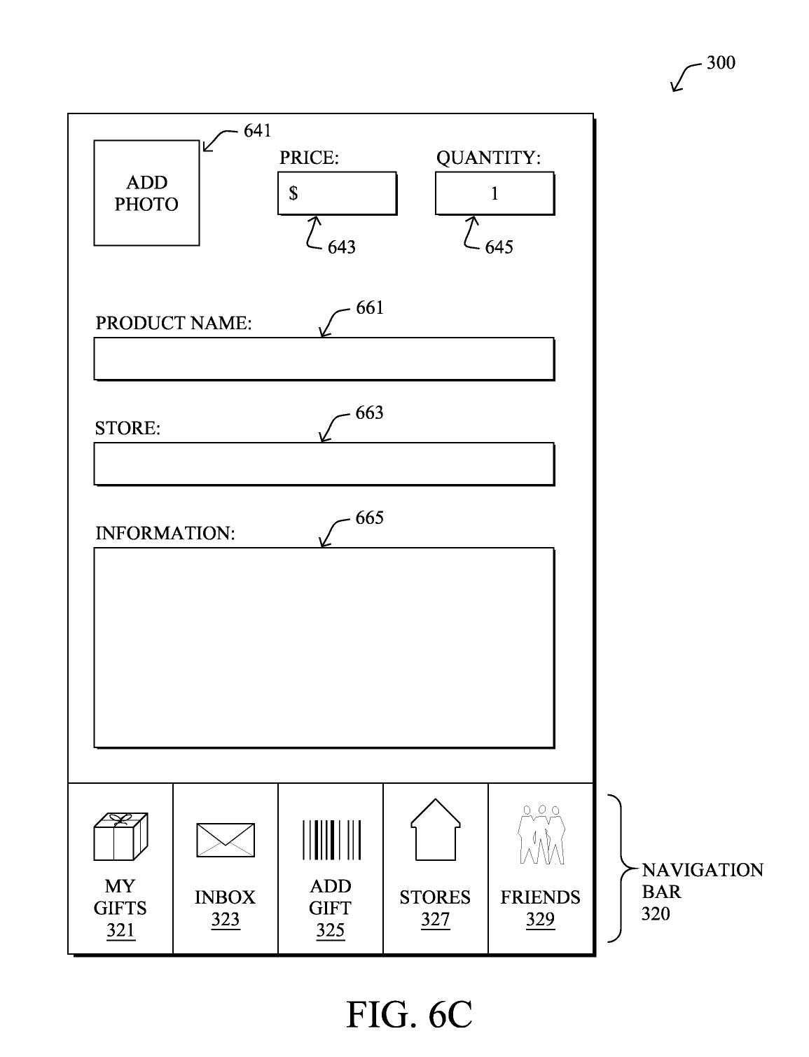

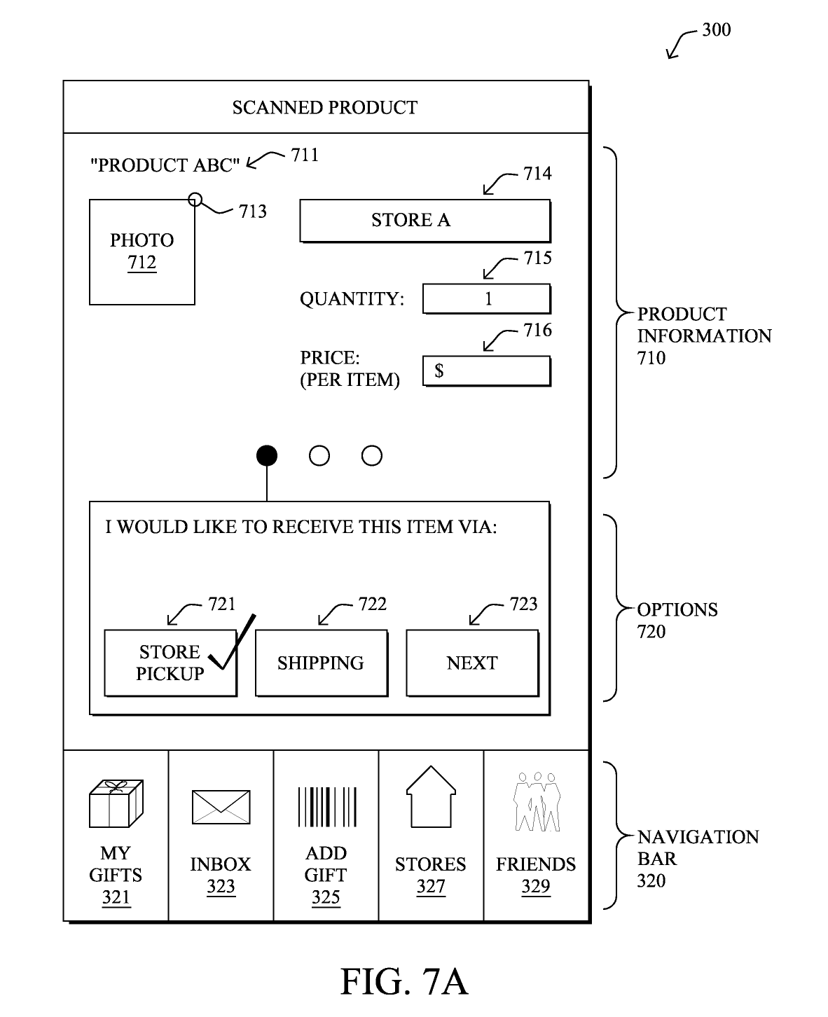

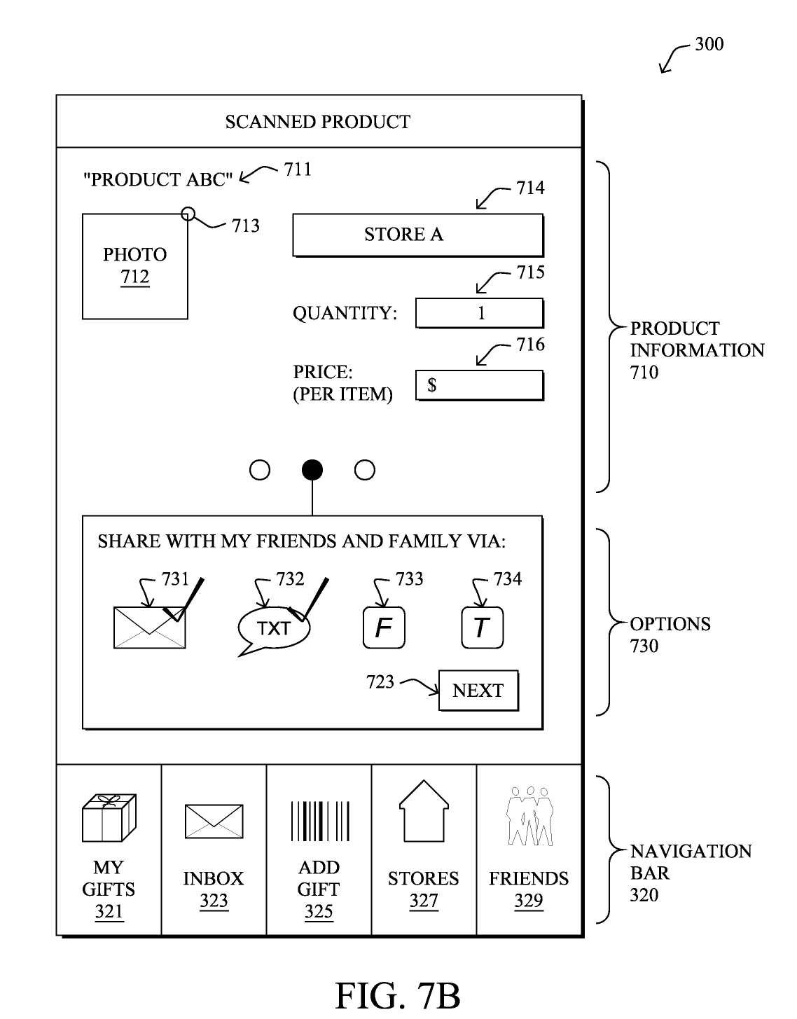

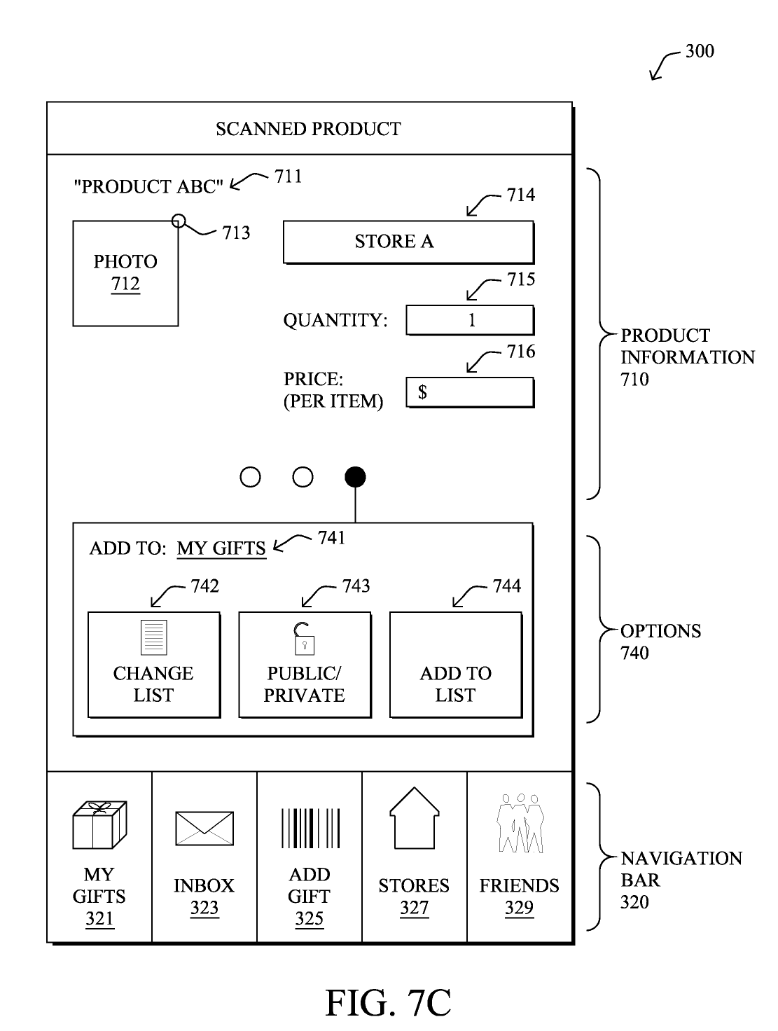

Once the user discovers a product he or she would like to have (and would like to have help paying for), the gifting app allows the user to enter a product code of the particular selected product. For example, as shown in FIG. 6A, a store may be selected as mentioned above in FIG. 5, or else within interface view 300 of FIG. 6A from store bar 610 (showing the selected “Store A” or the ability to scroll through other store choices). In one particular embodiment, the product code may be received by capturing is (scanning) an image of a barcode (e.g., merchant specific or else a universal product code or “UPC”) of the product, such as through code scanner window 620. By aiming the mobile device's camera at the barcode, the app, with or without user input, may detect and decipher (interpret) the barcode to identify, according to the product code and the particular merchant (unless a UPC), details of the particular product and an associated product price. In other words, the user may simply scan the product barcode, and the product info and price may “pop up” (appear) on their screen (as described below with reference to FIGS. 7A-7C). Alternatively, as shown in FIG. 6B, the user may perform a manual numeric input of the barcode/UPC via a user interface (keypad 625). User selection between FIGS. 6A and 6B (and 6C) may be made through menu bar 630. In still further embodiments, the app may allow (or prompt) a user to choose a gift from that store from a list of products, such as on-sale items, popular items, advertised items, etc.

Note that the barcode generally captures all of the product information including style, size, and color. That is, every color and size of a product generally has a unique barcode, so once the particular store's database is accessed (which may or may not require participation by the particular store), the app and gift platform will match the entered code to the exact product and the current price for that store. There are times, however, where a product has no code, or the code is not functioning as expected. For such times, the gifting app also provides a completely manual product entry mode. For instance, as shown in FIG. 6C, the interface 300 may allow a user to add a photo 641, a price 643, and a quantity 645 of a given product 661. Optionally, the user may also enter the particular store 663 from which the product is available, and additional description or information 665 as the user deems helpful to describe the product (e.g., a product description, a cute remark, a reason for the request, a short story, etc.). In the event that the bar code is recognized but does not indicate a specific color, size, etc., then a partial manual entry may be provided by the interface to allow users to enter such details. Otherwise, the users may simply be allowed to decide this upon redemption of the voucher to “pick-up” the item in store (or online for shipping).

Once users have found and entered gifts they would like to receive, they can use the gifting platform to tell their social circle (members of their social network, e.g., friends and family) of the gifts, whether individually or in associated lists. For instance, upon entering the product code (or manually entering the information), users may be presented with a short “wizard” on their app interface 300, such as shown in FIG. 7A. The product information 710 (or “details) of the scanned product may comprise a product name 711 (e.g., “Product ABC”), a photo 712 of the product, such as from a store catalogue of products, and the particular store 714 (e.g., Store A) from which the product is requested. The desired quantity 715 and price (e.g., per item) 716 may also be presented and/or edited. Note that users may be allowed to provide their own picture 712, such as by clicking on the camera icon 713 to switch the picture (e.g., making the process more personal by taking a picture of the users themselves with the gift). In other words, the gifting platform/app may be configured to accept a user-submitted picture as the picture associated with the details 710.

Within the options field 720 (e.g., the “wizard” noted above), the platform offers the option to have gifts picked up in store (option 721) or shipped to a predetermined address (option 722). That is, the app/platform may receive the users' selection of whether they desire a voucher for an in-store purchase or for a shipped purchase prior to continuing to a next option screen (“next” button 723).

Once the “next” button 723 is selected in FIG. 7A, the wizard illustratively moves to options 730, where the user is given the option to share the details of the particular product (and merchant/store and price) with members of his or her social circle using email 731, text messages (SMS) 732, or various social media 733 and 734 (e.g., FACEBOOK and TWITTER) or other accessible websites, etc. A broadcast message to all friends/family may result from various social media outlets, while selection of particular recipients is made available through email and text messaging (and in certain embodiments of social media as well).

Clicking “next” from FIG. 7B illustratively moves to options 740 in FIG. 7C, where the user may manage the specific list into which the selected product is placed (e.g., birthday list, holiday list, baby registry, etc.). For example, the current list “My Lists” 741 may be a default selection, while the icon 742 allows a user to edit the selected list. (Note that entire lists may be shared with friends and family as well, as described below, not just single items at a time.)

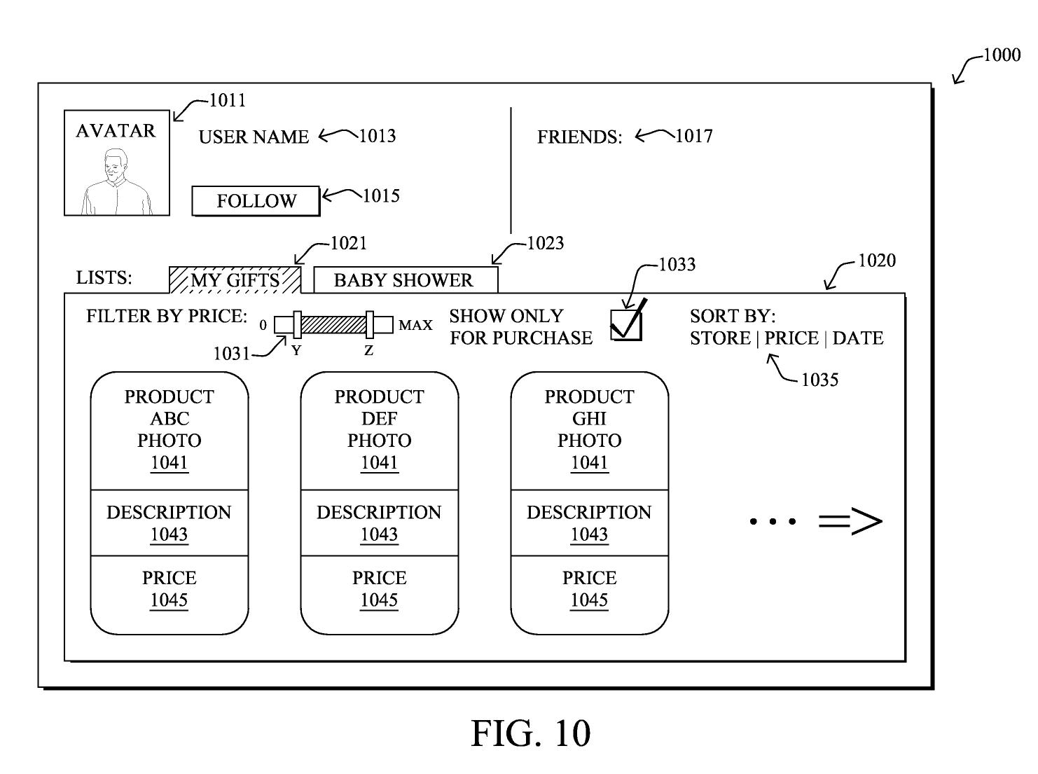

Also, since the platform provides a website to access a user's lists (e.g., shown and described below with reference to FIG. 10), the public/private option 743 allows a user to allow or prevent people from seeing the items on the list. For instance, while a public item or list may be viewed by everyone, by setting an item or list as private and then sharing the product via email or SMS only (e.g., as a link), only those recipients of the emails and text messages will be able to view the selected gift. Note also that in one embodiment where product details are shared in lists, certain lists may be associated with a plurality of users (co-registrants) that are allowed to share additional products to the list (e.g., registries, birthday lists shared between siblings for their parents, etc.).

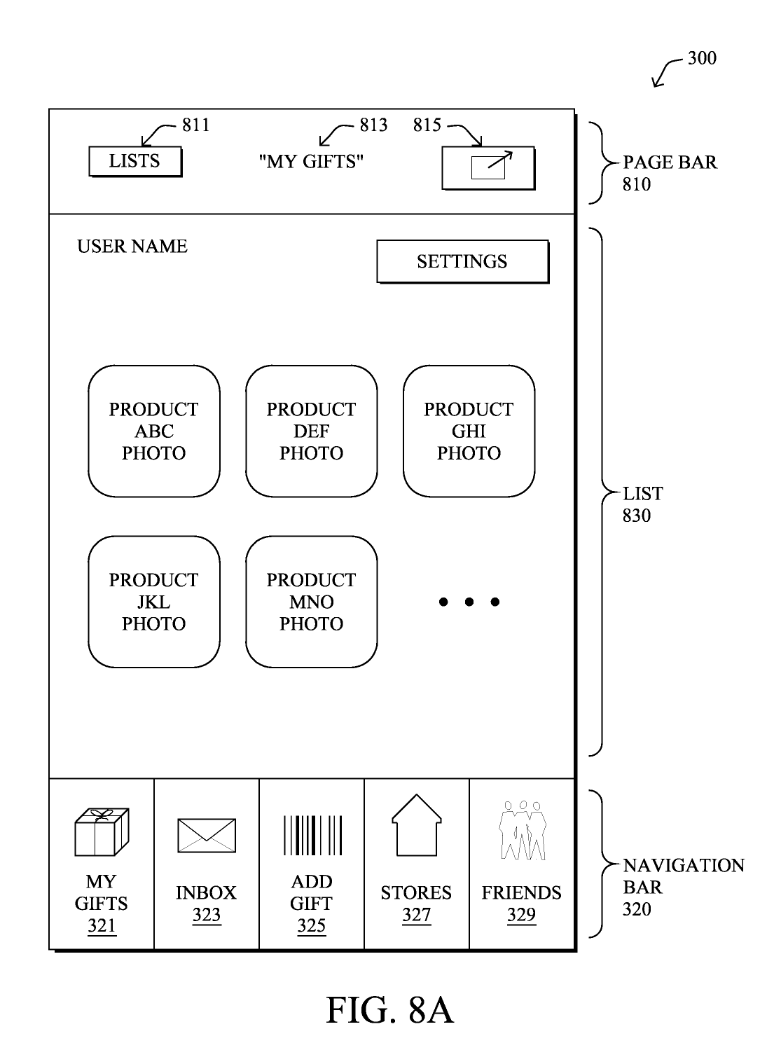

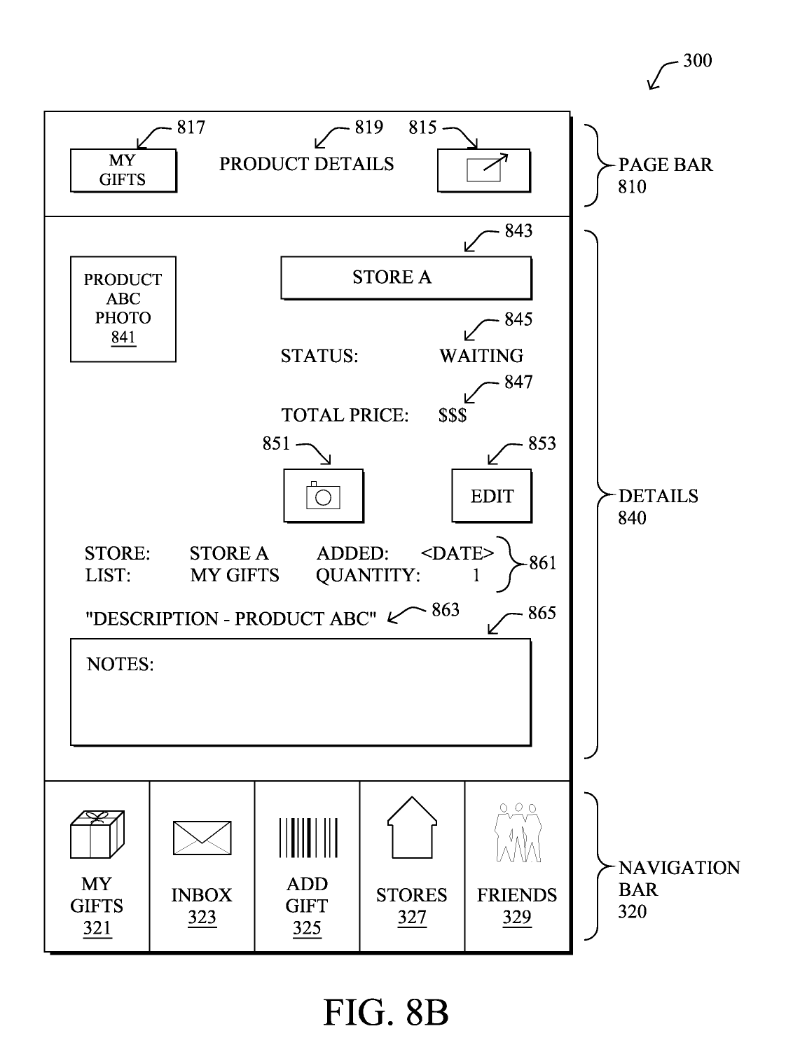

Once a product is added to the list (button 744), the product may be shared (if selected) and added to the desired list (e.g., “My Gifts”) accordingly. For instance, within the user's app, FIG. 8A illustrates an example interface 300 showing the insertion of Product ABC into the My Gifts list, where an illustrative page bar 810 allows a user to change the currently viewed list (button 811), labels the currently viewed list 813, and provides a button 815 for sharing the list. Within the list 830, a listing of the selected products, such as photos, names, etc., may appear in any particular order, selected by the user or preset by the app, such as by date, by price, alphabetically, etc.

Selecting a particular product from within the list 830 may bring the user's interface 300 to a product page as shown in FIG. 8B, where the page bar 810 is updated to reflect the ability to return to the list (button 817), an indication of the current view (product details label 819), and the ability to share the product individually (button 815 from the product details page). Illustratively, within the product details 840, the product photo 841 may be shown, along with the particular store 843, a status 845 of the gift (e.g., waiting, purchased, chipped-in, etc.), an option to change the picture (button 851), and an option 853 to edit various details, such as public/private settings, in which list the gift is located, adding notes to the description, removing the gift, etc. Other information 861, such as recapping the store, list name, date added, quantity requested, etc., may also be provided, in addition to the product description 863 and any user-added notes or information 865.

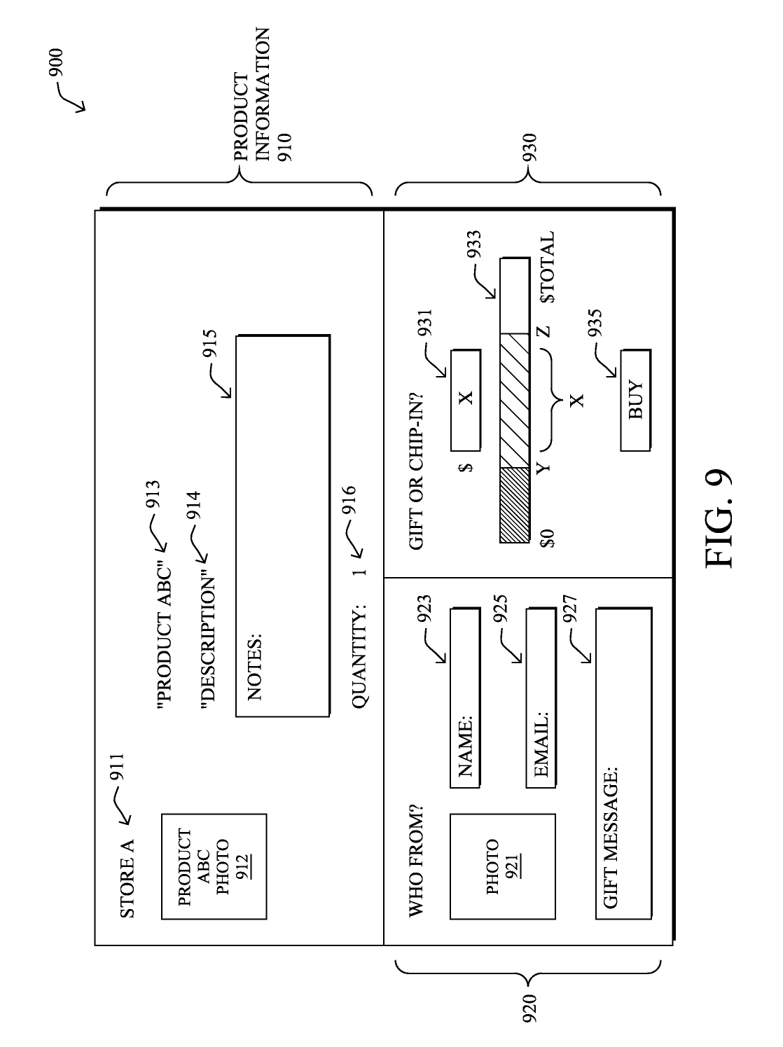

Sharing the products solicits friends and family to contribute funds toward a voucher for purchase of the particular product by the user from the particular merchant. In particular, in accordance with one or more embodiments herein, the selected members of the user's social network may receive a notification (email, social media, text messages) with a link directing them to the branded product page of a gifting platform website, such as website 900 of FIG. 9 configured to receive contributed funds. For example, in addition to the product information 910, such as the store name 911, the product photo 912, name 913, description 914, user-notes 915, and desired quantity 916, the website may also contain a personalization section 920 and a purchase transaction section 930. Specifically, section 920 may allow a contributor (friends, family, etc.) to provide a photo/avatar 921 of themselves (e.g., manually or obtained from a social media profile image), their name 923 (e.g., manually or based on their social media username), their email address 925, and also optionally to enter a gift message 927.

Transaction section 930 allows a contributor to gift the product outright, or else to “chip in” a portion of the funds toward purchase of the product (crowd sourcing). A currently selected contribution amount “X” 931 is shown, which as shown in contribution bar 933 would be added to a currently contributed amount “Y” (which may be $0) to bring the total contribution to “Z”, which, in the case of an outright gift or a sufficient amount of chipping in, is the total cost of the gift. In other words, for a complete gift, “X” is the total cost, while for a chipped-in gift, “Y” is the current level of contributions, “X” is the additional contribution of the current contributor, and “Z” is the end result of that new contribution (Z=Y+X). Once the contributors have made their selection, they can hit the “buy” button 935 to be brought to a conventional transaction page (e.g., credit cards, PAYPAL, etc.) to transfer funds from their personal accounts to the gifting platform.

After the purchase is finalized on the website 900 (i.e., in response to sufficient contributed funds for purchase of the particular product), the user receives a notification message (e.g., email, text, pushed notification to the app, etc.). In one or more embodiments herein, the provided notification contains a redemption code of the voucher (e.g., presented as a store-scannable barcode displayed on a user interface or a reference number displayed on a user interface), which can then be redeemed in the store (where originally located or not) to obtain the desired gift. (Note that the provided notification may be formatted according to whether the voucher is for an in-store purchase or a shipped purchase; for example, for shipping, the notification may be linked to the merchant's online store, e.g., with the voucher code pre-populated.) As used herein, a “voucher” may be used to generally imply evidence of payment or credit confirmation (e.g., representing credit against a future transaction).

To ensure that the merchant's PoS (point of sale) recognizes the voucher and rings up the sale, in one embodiment, the gifting platform sends a request (e.g., via an API) to a universally accepted gift card or pre-paid card merchant for a card number representing the amount of the purchase, and receives an electronic gift card (an “e-gift card”) number in return to send to the user, in numeric form and/or scannable barcode form. Note that the gift card number (the voucher) may represent an open voucher (generic value not tied to a particular merchant, such as a VISA or AMERICAN EXPRESS prepaid card), a closed voucher (tied to the specific merchant, such as a TARGET or SEARS prepaid card), or a novel “super-closed” voucher (tied to the specific product at the specific merchant). Closed vouchers, unlike open vouchers, prevent the users from purchasing the products from a different merchant, while super-closed vouchers prevent the users from purchasing other products from the merchant aside from the actual gifted product (e.g., preventing a student from using funds intended for books to purchase video games instead). In the case of an open or closed voucher, if an item is out-of-stock, backordered, or otherwise unavailable, the user may buy something else within that price range using the voucher. (In the case of a closed voucher, the substitute must be at the same merchant; in the case of an open voucher, the substitute may be at any merchant honoring the relevant card.) Also, open or closed vouchers may allow a user to request funds generally, such as a gift certificate, through the gifting platform, where the user can then choose how to apply the obtained funds.

In certain embodiments, and in certain circumstances, one or more friends or family may contribute (chip in) to a particular product, but do not reach the full amount (ever or within a certain time frame). Accordingly, the techniques herein allow a user to click on a gift in their list and hit a “cash in” option, such that the amount collected until that point will be put on a gift card and sent to their inbox. Said differently, the user may instruct the app/platform to redeem a voucher prior to sufficient contributed funds for purchase of the particular product, and receives a provided redemption code (voucher) for use with the particular merchant with a current level of contributed funds. The user can then add to the amount of contributed funds when checking out with the originally desired product, or else may simply choose something else within budget at the particular merchant's store (or for open vouchers/gift cards, any store).

FIG. 10 illustrates an example simplified webpage 1000 that may be accessed by users themselves or by members of their social networks. The webpage 1000 is generally a user “gifting profile” page that may be used to track a user's gifts, lists, etc. For instance, the users avatar/photo 1011 and user name 1013 may identify the particular user associated with the page. A “follow” button 1015 allows visitors to the page (members of the social circle or not) to be notified of user activity (newly added gifts, lists, etc.) in a manner conventional with social media following as will be understood in the art. Additionally, a friends section 1017 may indicate one or more members of the user's social network that are shared with a visitor of the site, that are participants of the gifting platform, or that have contributed to the user's gifts in the past, etc.

The webpage 1000 may be configured to display one or more gift lists 1020, such as the illustrative “My Gifts” list (selected tab 1021), a “Baby Shower” list (tab 1023), etc. The format of the lists, tabs, items, etc., are configurable, and may allow searching and purchasing from the various lists, accordingly. For example, a price filter bar 1031 may limit displayed items to within a range between “Y” ($0 or greater) and “Z” (up to a maximum price), and a checkbox 1033 may limit displayed items to only those still available for purchase. Other options are available within the scope of the embodiments herein, such as limiting displayed items to those that have been purchased, those that are being chipped into, etc. Also, the lists and/or products may be sorted according to store, price, date, etc. (sort buttons/links 1035). The result of the search and display limitations may then be shown within the list box 1020, such as with a photo 1041, a description 1043 (e.g., abbreviated or a simple product name), a price 1045, and any other useful information. From this website 1000, users can also see their lists (that is, without going through the app interface), and contributors may select various products to purchase (or chip in for), thus being directed to webpage 900 of FIG. 9 to complete the transaction as described above.

According to one or more embodiments described herein, the gifting platform also offers merchants/retailers a backend interface to access and manage useful information regarding the shoppers in their stores. For instance, the platform may provide real-time monitoring of apps within one of their stores, such as by allowing merchants to log into a dashboard (interface) and view the users in their stores who are currently using the app, the products being scanned, the products being purchased, etc. The merchants may also manage users while they are browsing the store and offer promotions, etc., such as giving a discount to users located within a given mall at a particular time, etc. Moreover, the platform may provide shopping analytics to the merchants/retailers, such as based on patterns of users sharing particular products. For example, the platform may generate and aggregate lists of desired items and gifts (including item properties), real time shopping locations, venue purchase preferences, gifting trends, user spending data, social spending circles, etc. Such analytics give the merchants a better understanding of customer buying patterns and product preferences and the ability to entice and promote in real time.

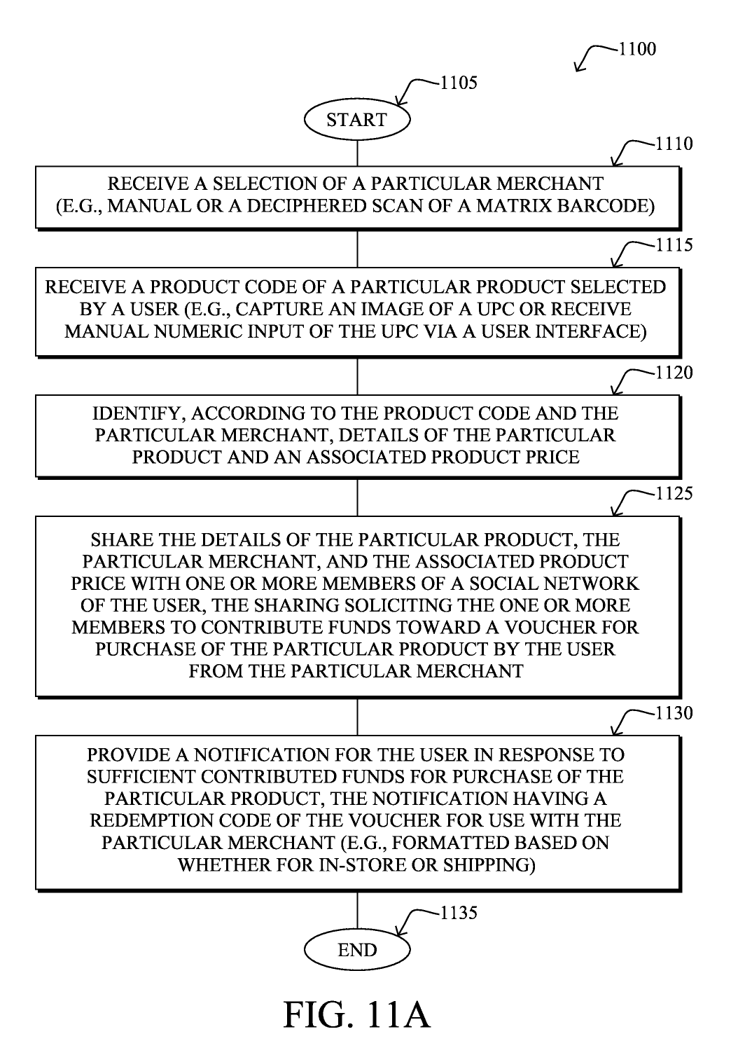

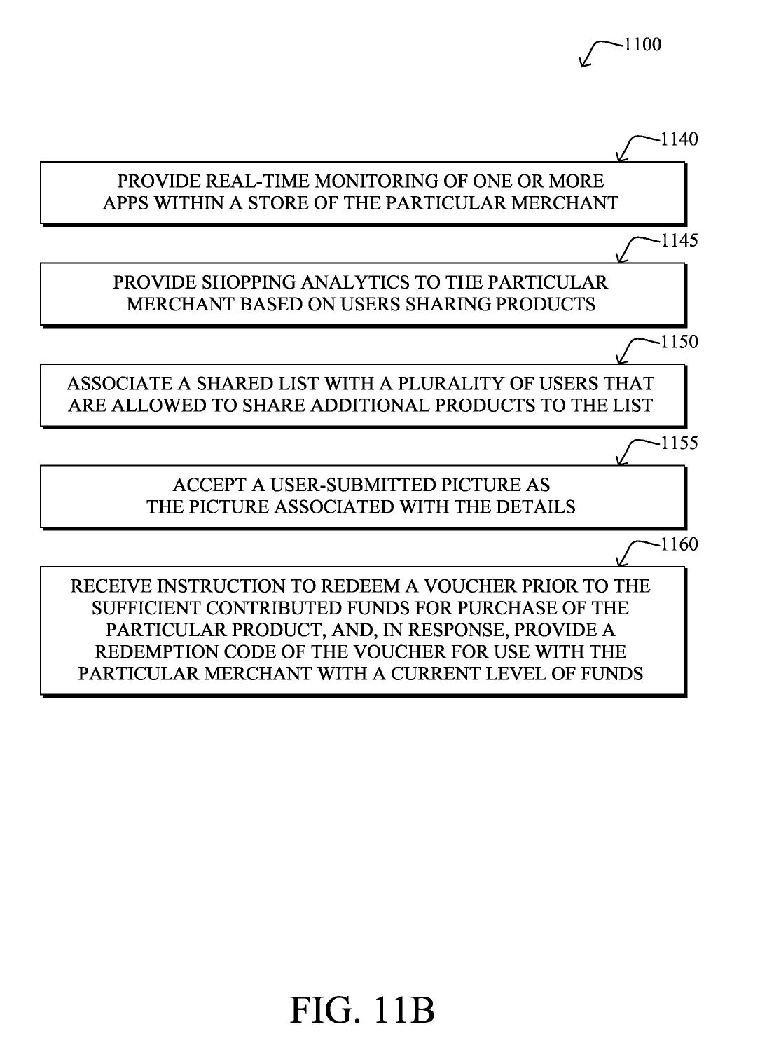

FIG. 11A illustrates an example simplified procedure 1100 for end-to-end in-store online gifting in accordance with one or more embodiments described herein. Notably, the procedure 1100 may be performed by an app (e.g., presented as a GUI) on a user's personal device 110, and/or performed by a server in remote communication with the app (e.g., gifting platform, 140). The procedure 1100 may start at step 1105, and continues to step 1110, where, as described in greater detail above, the app or server receives a selection of a particular merchant/store, such as through manual entry or a deciphered scan of a matrix barcode (e.g., where the app accepts the selection, and the server is receives it from the app). In addition in step 1115, the app or server also receives a product code of a particular product selected by a user. For instance, as detailed above, the app may capture an image of a barcode or receive manual numeric input of the barcode via a user interface, which may be sent to the server, accordingly.

In step 1120, details of the particular product and an associated product price may be identified according to the product code and the particular merchant (e.g., the image, description, and price of product ABC). In step 1125, the app or server (e.g., under user command) may then share the details of the particular product, the particular merchant, and the associated product price with one or more members of a social network of the user (e.g., friends and family). Specifically, as mentioned above, the sharing solicits the one or more members to contribute funds toward a voucher for purchase of the particular product by the user from the particular merchant. As such, in response to sufficient contributed funds for purchase of the particular product, in step 1130 a notification is provided for the user, where the notification has a redemption code of the voucher for use with the particular merchant (e.g., formatted based on whether for in-store or shipping). The illustrative simplified procedure 1100 then ends in step 1135.

In addition, FIG. 11B illustrates example optional steps (in no particular order) that may be incorporated into procedure 1100 of FIG. 11A. For example, in step 1140, the server may provide real-time monitoring of one or more apps within a store of the particular merchant, and in step 1145, the server may also provide shopping analytics to the particular merchant based on users sharing products. Also, in step 1150, a shared list may be associated with a plurality of users that are allowed to share additional products to the list (e.g., adding co-registrants). Further, in step 1155, the app (or server) may accept a user-submitted picture as the picture associated with the product details. As also mentioned above, in step 1160, the app or server may receive instruction to redeem a voucher prior to the sufficient contributed funds for purchase of the particular product, and, in response, may then provide a redemption code of the voucher for use with the particular merchant with a current level of funds.

It should be noted that while certain steps within procedure 1100 may be optional as described above, the steps shown in FIGS. 11A-11B are merely examples for illustration, and certain other steps may be included or excluded as desired. For example, store selection (and tying the item to a store, generally) may be excluded, thus allowing for a generic voucher to be obtained by a user. Further, where a particular order of the steps is shown, this ordering is merely illustrative, and any suitable arrangement of the steps may be utilized without departing from the scope of the embodiments herein. For example, the platform may be configured to allow the user to first scan an item and then to supply the user with a list of stores that sell this particular item, etc.

Advantageously, the techniques herein allow shoppers to maintain the in-store experience, while facilitating online social funding (e.g., “crowd sourcing”) in a manner that reinvents shopping and gift giving by integrating the traditional store shopping into an end-to-end internet/mobile phone platform that is easy to use for both the gift recipient and the gift giver. In particular, the techniques herein further enhance shopping, item selection, and gifting. For example, the platform facilitates the scanning, sharing, and purchasing of multiple items in multiple stores, thus may be used to create gift registry lists from multiple stores, large or small, where in-store selections are finalized online. (Specifically, the techniques herein do not source the internet to compare prices, but rather tie the product to the particular physical or on-line store in which the user is shopping. At the same time, however, such a comparison may also be configured within the feature set of the application.)

Also, while the embodiments above have been directed to a specific process, various components of the process may also be specifically claimed herein, whether individually or within alternate embodiments. For instance, in one alternate embodiment, rather than a user operating the app to solicit funds for a desired gift from his or her social network, the app user may be purchasing an unsolicited gift for another member of the social network. For example, a user may locate an unsolicited gift within a store, then scans or enters the barcode, and may purchase the gift on their mobile device to have a voucher for the gift sent to a selected receiving member of the user's social network, who may then pick up the gift in a local store or have it shipped to them. Still further, the user may submit the unsolicited gift to a list unseen by the selected receiving member, such that other members of the social network (the app user's or the selected receiving member's) may contribute funds toward the purchase of the gift without knowledge of the selected receiving member.

The applications or processes described herein can be implemented as a series of computer-readable instructions, embodied or encoded on or within a tangible data storage medium, that when executed are operable to cause one or more processors to implement the operations described above. The foregoing processes and mechanisms can be implemented by a wide variety of physical systems and in a wide variety of network and computing environments; the computing systems described below provide example computing system architectures of the server and client systems described above, for didactic, rather than limiting, purposes.

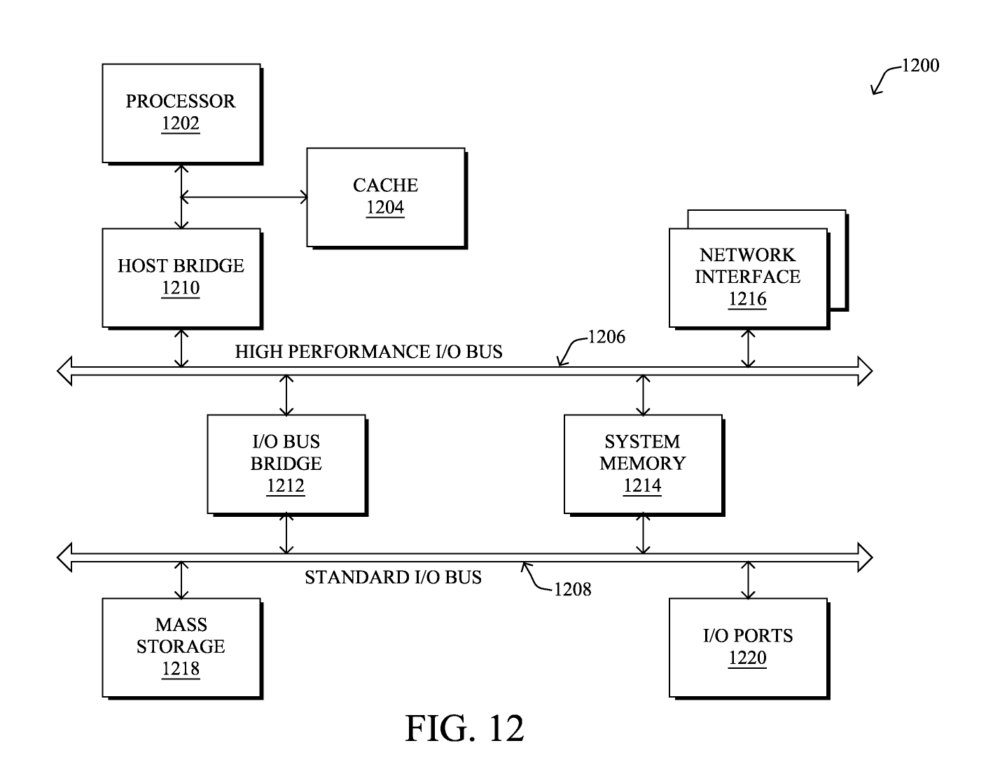

FIG. 12 illustrates an example computing system architecture, which may be used to implement a server, a client device, etc. In one embodiment, hardware system 1200 comprises a processor 1202, a cache memory 1204, and one or more executable modules and drivers, stored on a tangible computer readable medium, directed to the functions described herein. Additionally, hardware system 1200 includes a high performance input/output (I/O) bus 1206 and a standard I/O bus 1208. A host bridge 1210 couples processor 1202 to high performance I/O bus 1206, while I/O bus bridge 1212 couples the two buses 1206 and 1208 to each other. A system memory 1214 and one or more network/communication interfaces 1216 couple to bus 1206. Hardware system 1200 may further include video memory (not shown) and a display device coupled to the video memory. Mass storage 1218, and I/O ports 1212 couple to bus 1208. Hardware system 1200 may optionally include a keyboard and pointing device, and a display device (not shown) coupled to bus 1208. Collectively, these elements are intended to represent a broad category of computer hardware systems, including but not limited to general purpose computer systems.

The elements of hardware system 1200 are described in greater detail below. In particular, network interface 1216 provides communication between hardware system 1200 and any of a wide range of networks, such as an Ethernet (e.g., IEEE 802.3) network, a backplane, cellular, WiFi, etc. Mass storage 1218 provides permanent storage for the data and programming instructions to perform the above-described functions implemented in the servers or client devices, whereas system memory 1214 (e.g., DRAM) provides temporary storage for the data and programming instructions when executed by processor 1202. I/O ports 1220 are one or more serial and/or parallel communication ports that provide communication between additional peripheral devices, which may be coupled to hardware system 1200.

Hardware system 1200 may include a variety of system architectures; and various components of hardware system 1200 may be rearranged. For example, cache 1204 may be on-chip with processor 1202. Alternatively, cache 1204 and processor 1202 may be packed together as a “processor module,” with processor 1202 being referred to as the “processor core.” Furthermore, certain embodiments of the present invention may not require nor include all of the above components. For example, the peripheral devices shown coupled to standard I/O bus 1208 may couple to high performance I/O bus 1206. In addition, in some embodiments, only a single bus may exist, with the components of hardware system 1200 being coupled to the single bus. Furthermore, hardware system 1200 may include additional components, such as additional processors, storage devices, or memories.

In one implementation, the operations of the embodiments described herein are implemented as a series of executable modules run by hardware system 1200, individually or collectively in a distributed computing environment. In a particular embodiment, a set of software modules and/or drivers implements a network communications protocol stack, browsing and other computing functions, optimization processes, and the like. The foregoing functional modules may be realized by hardware, executable modules stored on a computer readable medium, or a combination of both. For example, the functional modules may comprise a plurality or series of instructions to be executed by a processor in a hardware system, such as processor 1202. Initially, the series of instructions may be stored on a storage device, such as mass storage 1218. However, the series of instructions can be tangibly stored on any suitable storage medium, such as a diskette, CD-ROM, ROM, EEPROM, etc. Furthermore, the series of instructions need not be stored locally, and could be received from a remote storage device, such as a server on a network, via network/communications interface 1216. The instructions are copied from the storage device, such as mass storage 1218, into memory 1214 and then accessed and executed by processor 1202.

An operating system manages and controls the operation of hardware system 1200, including the input and output of data to and from software applications (not shown). The operating system provides an interface between the software applications being executed on the system and the hardware components of the system. Any suitable operating system may be used, such as the LINUX Operating System, the Apple Macintosh Operating System, “iOS” of Apple Computer Inc., the Android Operating System, UNIX operating systems, Microsoft (r) Windows(r) operating systems, BSD operating systems, and the like.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

In particular, the foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible (non-transitory) computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. By way of example, while embodiments of the present invention have been described as operating in connection with a social networking website, the present invention can be used in connection with any communications facility that supports web applications. Furthermore, in some embodiments the term “web service” and “web-site” may be used interchangeably and additionally may refer to a custom or generalized API on a device, such as a mobile device (e.g., cellular phone, smart phone, personal GPS, personal digital assistance, personal gaming device, etc.), that makes API calls directly to a server.

Finally, the language used in the specification has been principally selected for readability and instructional purposes, and was not selected to—nor should it be interpreted to—delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
receiving a selection of a particular merchant;
receiving a product code of a particular product selected by a user;
identifying, according to the product code and the particular merchant, details of the particular product and an associated product price;
sharing the details of the particular product, the particular merchant, and the associated product price with one or more members of a social network of the user, the sharing soliciting the one or more members to contribute funds toward a voucher for purchase of the particular product by the user from the particular merchant; and
providing a notification for the user in response to sufficient contributed funds for purchase of the particular product, the notification having a redemption code of the voucher for use with the particular merchant.

2. The method as in claim 1, wherein the method is performed by an app on a personal device of the user, wherein the app is presented as a graphical user interface to the user on the personal device.

3. The method as in claim 1, wherein the method is performed by a server in remote communication with a user interface app on a personal device of the user.

4. The method as in claim 3, further comprising:
providing real-time monitoring of one or more apps within a store of the particular merchant.

5. The method as in claim 3, further comprising:
providing shopping analytics to the particular merchant based on users sharing products.

6. The method as in claim 1, wherein receiving the product code comprises one of either capturing an image of a barcode or receiving manual numeric input of the barcode via a user interface.

7. The method as in claim 1, further comprising:
receiving selection of whether the voucher is for an in-store purchase or a shipped purchase;
wherein the provided notification is formatted according to whether the voucher is for an in-store purchase or a shipped purchase.

8. The method as in claim 1, further comprising:
sharing the details within a list; and
associating the list with a plurality of users that are allowed to share additional products to the list.

9. The method as in claim 1, wherein a picture of the particular product is associated with the details of the particular product, the method further comprising:
accepting a user-submitted picture as the picture associated with the details.

10. The method as in claim 1, wherein receiving the selection of the particular merchant comprises:
deciphering a scan of a matrix barcode located at a store of the particular merchant.

11. The method as in claim 1, further comprising:
receiving instruction to redeem a voucher prior to the sufficient contributed funds for purchase of the particular product; and, in response, providing a redemption code of the voucher for use with the particular merchant with a current level of funds.

12. The method as in claim 1, wherein the voucher is selected from a group consisting of: a closed voucher; an open voucher; and a super-closed voucher.

13. The method as in claim 1, wherein the redemption code of the voucher is presented as one or both of a store-scannable barcode displayed on a user interface or a reference number displayed on a user interface.

14. The method as in claim 1, wherein sharing comprises:
notifying the one or more members via communication selected from a group consisting of: email; social media; text messages; and accessible websites; and
directing, via the notifying, the one or more members to a website configured to receive contributed funds.

15. A tangible, non-transitory, computer-readable media having software encoded thereon, the software when executed by a processor operable to:
receive a selection of a particular merchant;
receive a product code of a particular product selected by a user;
identify, according to the product code and the particular merchant, details of the particular product and an associated product price;
share the details of the particular product, the particular merchant, and the associated product price with one or more members of a social network of the user, the sharing soliciting the one or more members to contribute funds toward a voucher for purchase of the particular product by the user from the particular merchant; and
provide a notification for the user in response to sufficient contributed funds for purchase of the particular product, the notification having a redemption code of the voucher for use with the particular merchant.

16. The computer-readable media as in claim 15, wherein the software is executed as an app on a personal device of the user, wherein the app is presented as a graphical user interface to the user on the personal device.

17. The computer-readable media as in claim 15, wherein the software is executed as a process on a server in remote communication with a user interface app on a personal device of the user.

18. The computer-readable media as in claim 17, wherein the software when executed is further operable to:
provide real-time monitoring of one or more apps within a store of the particular merchant.

19. The computer-readable media as in claim 17, wherein the software when executed is further operable to:
provide shopping analytics to the particular merchant based on users sharing products.

20. An apparatus, comprising:
one or more network interfaces to communicate with a communication network;
a processor coupled to the network interfaces and adapted to execute one or more processes; and
a memory configured to store a process executable by the processor, the process when executed operable to:
receive a selection of a particular merchant;
receive a product code of a particular product selected by a user;
identify, according to the product code and the particular merchant, details of the particular product and an associated product price;
share the details of the particular product, the particular merchant, and the associated product price with one or more members of a social network of the user, the sharing soliciting the one or more members to contribute funds toward a voucher for purchase of the particular product by the user from the particular merchant; and
provide a notification for the user in response to sufficient contributed funds for purchase of the particular product, the notification having a redemption code of the voucher for use with the particular merchant.

21. A method, comprising:
receiving a selection of a particular merchant;
receiving a product code of a particular product selected by a first user;
identifying, according to the product code and the particular merchant, details of the particular product and an associated product price;
accepting contributed funds toward a voucher for purchase of the particular product from the particular merchant; and
providing a notification to a second user in response to sufficient contributed funds for purchase of the particular product, the notification having a redemption code of the voucher for use with the particular merchant by the second user.

22. The method as in claim 21, further comprising:
sharing the details of the particular product and the particular merchant with one or more members of a social network, the sharing soliciting the one or more members to contribute funds toward the voucher for purchase of the particular product from the particular merchant.
